(19) United States
(12) Patent Application Publication
(10) Pub. No.: US 2004/0017034 A1
(43) Pub. Date: Jan. 29, 2004

(54) Vibration isolating bushing

(75) Inventors: Seiya Asano, Aichi (JP); Kazuhiko Kato, Aichi (JP)

Correspondence Address: DARBY & DARBY P.C., P. O. BOX 5257, NEW YORK, NY, 10150-5257, US

(73) Assignee: TOKAI RUBBER INDUSTRIES, LTD., Komaki-Shi (JP)

(21) Appl. No.: 10/600,479

(22) Filed: Jun. 19, 2003

(30) Foreign Application Priority Data
Jun. 27, 2002 (JP) 2002-188185

(51) Int. Cl. F16F 7/00

(52) U.S. Cl. 267/141.2; 267/293

(57) ABSTRACT

A vibration isolating bushing includes: a main shaft member having a tubular portion, a flange portion, and a block portion; an outer cylinder member disposed coaxially with the main shaft member; and a rubber elastic body disposed between the main shaft member and the outer cylinder member. The rubber elastic body includes a hollow portion opening in an end face away from the flange portion and extends in the axial direction up to the vicinity of an end face on a side of the flange portion. The rubber elastic body further includes: a non-deforming rubber portion positioned between the flange portion and the block portion being substantially undeformable by an axial load; and a connecting portion for connecting the non-deforming rubber portion and an inner peripheral surface of an end portion of the outer cylinder member.

The present disclosure relates to the subject matter contained in Japanese Patent Application No. 2002-188185 filed Jun. 27, 2002, which is incorporated herein by reference in its entirety.

### BACKGROUND OF THE INVENTION

1. Field of the Invention

The present invention relates to a vibration isolating bushing which is suitably used as, for example, a trailing arm bushing, a compression rod bushing, or the like in a suspension of an automobile.

2. Background Art

Conventionally, vibration isolating bushings having various structures are used in a suspension of an automobile to connect an arm member or a rod member, on the one hand, and a vehicle body, on the other hand, in a vibration isolated manner. For example, vibration isolating bushings disclosed in JP-A-11-153180 and JP-A-10-238574 are known. Such a vibration isolating bushing is generally comprised of a main shaft member which is fixed to either one of two members to be connected in a vibration isolated manner; an outer cylinder member which is disposed coaxially on the outer side of that main shaft member at a distance therefrom, and is fixed to the other one of the two members to be connected in a vibration isolated manner; and a rubber elastic body disposed between that outer cylinder member and the main shaft member for integrally connecting the two members. It should be noted that, as for the rubber elastic body of this vibration isolating bushing, since its spring acting in a direction perpendicular to the axis needs to be adjusted in a direction in which its phase is offset 90°, a pair of hollow portions extending in the axial direction are provided at axially symmetrical positions with the main shaft member located therebetween.

### SUMMARY OF THE INVENTION

In a rear suspension, a trailing arm bushing which is used for connecting a trailing arm and a vehicle body in a vibration isolated manner is mounted as follows: A main shaft member, for instance, is fixed to the vehicle body by means of mounting bolts or the like, and an outer cylinder member is press fitted and fixed in a mounting hole provided in the trailing arm. The axial direction of the bushing is set substantially in the longitudinal direction of the automobile, and the hollow portions in the rubber elastic body are arranged in a state of being located substantially in the vertical direction of the automobile. As the bushing is thus arranged, when the automobile turns, the spring action in the direction perpendicular to the axis and in the axial direction of the rubber elastic body harmonizes, thereby functioning to cause the rear tire to undergo a toe-in. Normally, the spring ratio between the direction perpendicular to the axis of the bushing (the vertical direction of the automobile) and the axial direction thereof (the longitudinal direction of the automobile) is set to 1:0.4 or thereabouts. However, if the spring in the longitudinal direction of the automobile (the axial direction of the bushing) is low, the toe-in of the rear tire becomes delayed. Therefore, to suppress that phenomenon, it is necessary to increase the spring in the axial direction of the bushing.

The following methods are known as conventionally practiced techniques for increasing the spring ratio in the axial direction:

(1) An increase in the Rubber Hardness of the Rubber Elastic Body

Namely, the rubber hardness is increased by adjusting such as the axial length and the radial thickness and width of the rubber elastic body, thereby increasing the spring in the axial direction.

(2) Addition of an Axial Stopper (JP-A-11-153180, Etc.)

Namely, an elastic stopper is provided on the outer cylinder member or the like to restrict the axial displacement, and the spring in the axial direction is increased by the spring of that elastic stopper.

(3) Addition of an Axially Compressive Portion of the Rubber Elastic Body (JP-A-11-182598, Etc.)

Namely, a pair of axially opposing flange portions are respectively provided on one end sides of the main shaft member and the outer cylinder member. A portion of the rubber elastic body is disposed between the two flange portions, and an axially compressive portion is thereby provided, so as to increase the spring in the axial direction.

However, in the case (1) in which the rubber hardness of the rubber elastic body is increased, there is a problem in that the margin of increase in the spring ratio is small in the light of the characteristics such as durability and rubber hardness. In addition, in the case (2) in which the axial stopper is added and the case (3) in which the axially compressive portion of the rubber elastic body is added, there are problems in that the vibration isolating bushing becomes large in size and high in cost.

The invention has been devised in view of the above-described circumstances, and its object is to provide a vibration isolating bushing which is capable of increasing the spring ratio in the axial direction while preventing the vibration isolating bushing from becoming large in size and high in cost.

To overcome the above-described problems, the invention provides a vibration isolating bushing including: a main shaft member including a tubular portion, a flange portion extending radially outwardly from one end of the tubular portion, and a block portion provided on a central portion of the tubular portion and distanced from the flange portion in an axial direction of the main shaft member; an outer cylinder member disposed coaxially on an outer side of the main shaft member at a distance therefrom; and a rubber elastic body disposed between the main shaft member and the outer cylinder member for integral connection of the main shaft member and the outer cylinder member, the rubber elastic body including a hollow portion which is open in an end face away from the flange portion and extends in the axial direction up to the vicinity of an end face on a side of the flange portion. The rubber elastic body further includes a non-deforming rubber portion and a connecting portion. The non-deforming rubber portion is positioned between the flange portion and the block portion and is substantially undeformable with respect to an application of an axial load. The connecting portion is positioned between a bottom of the hollow portion and the end face of the rubber elastic body on the side of the flange portion, connecting the non-deforming rubber portion and an inner peripheral surface of an end portion of the outer cylinder member.

In the vibration isolating bushing, the spring in the axial direction is increased since the rubber elastic body is provided with the hollow portion, the non-deforming rubber portion, and the connecting portion. Therefore, it is possible to increase the spring ratio in the axial direction with respect to the direction perpendicular to the axis. In this case, the non-deforming rubber portion is provided between the flange portion and the block portion of the main shaft member, and the connecting portion is provided so as to connect the non-deforming rubber portion and the inner peripheral surface of the end portion of the outer cylinder member. Therefore, the vibration isolating bushing can be prevented from becoming large in size and high in cost as compared with conventional cases in which an axial stopper is added and an axially compressive portion of the rubber elastic body is added.

Therefore, according to the vibration isolating bushing of the invention, it is possible to increase the spring ratio in the axial direction while preventing the vibration isolating bushing from becoming large in size and high in cost.

Preferably, the block portion has a radially outwardly protruding end face located more inwardly than an outer peripheral end of the flange portion.

According to this arrangement, the structure can be made such that the axial load applied to the rubber elastic body can be easily relieved by receiving the resistance of the flange portion. Thus the non-deforming rubber portion which is disposed between the flange portion and the block portion can be provided advantageously.

Preferably, the connecting portion is formed in a state of being offset axially inwardly of the non-deforming rubber portion.

According to this arrangement, the structure becomes such that a compressive component is added with respect to the application of the axial load, so that it is possible to effectively increase the spring in the axial direction of the rubber elastic body.

### BRIEF DESCRIPTION OF THE DRAWINGS

The present invention may be more readily described with reference to the accompanying drawings:

FIG. 1 is a cross-sectional view taken along the axial direction of a vibration isolating bush in accordance with an embodiment of the invention, and is a cross-sectional view taken in the directions of arrows along lines I-I of FIG. 2; and

FIG. 2 is a left side elevational view of the vibration isolating bushing in accordance with the embodiment of the invention shown in FIG. 1.

### DETAILED DESCRIPTION OF THE PREFERRED EMBODIMENTS

Hereafter, a description will be given of an embodiment of the invention with reference to the drawings.

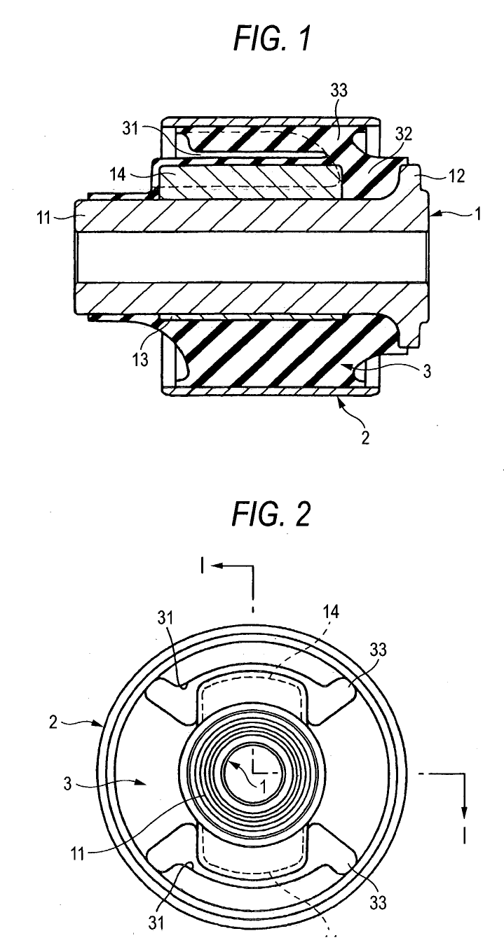

FIG. 1 is a cross-sectional view taken along the axial direction of a vibration isolating bush in accordance with this embodiment, and is across-sectional view taken in the directions of arrows along lines I-I of FIG. 2. FIG. 2 is a left side elevational view of the vibration isolating bushing shown in FIG. 1.

As shown in FIGS. 1 and 2, the vibration isolating bushing of this embodiment is comprised of a main shaft member 1 including a tubular portion 11, a flange portion 12, and a pair of block portions 14; an outer cylinder member 2 disposed coaxially on the outer side of the main shaft member 1 at a distance therefrom; and a rubber elastic body 3 disposed between the main shaft member 1 and the outer cylinder member 2 for integrally connecting the two members and including a pair of axially extending hollow portions 31, a pair of non-deforming rubber portions 32, and a pair of connecting portions 33.

The tubular portion 11 of the main shaft member 1 is formed of a metal such as steel in a straight thick-walled cylindrical shape. The annular flange portion 12 extending radially outwardly is formed integrally with the tubular portion 11 at one end portion of this tubular portion 11. Further, a block member, which consists of a cylindrical portion 13 and the pair of block portions 14 projecting radially outwardly from the outer peripheral surface of that cylindrical portion 13, is fitted and fixed around an outer periphery of a central portion of the tubular portion 11. The block member is formed integrally of a metal such as steel.

The pair of block portions 14 are provided at axially symmetrical positions with the tubular portion 11 located therebetween. Each of these block portions 14 has a length which is approximately one half of the axial length of the tubular portion 11 and has a width substantially identical to the outside diameter of the tubular portion 11. Each block portion 14 is formed into a block whose cross section is circular arc-shaped. Each block portion 14 formed is of such a size that its radially outwardly protruding end face (outer peripheral surface) is located somewhat radially inwardly of the outer peripheral end of the flange portion 12. Each block portion 14 is disposed such that one axial end face thereof opposes the flange portion 12 at a distance therefrom.

The outer cylinder member 2 is formed of a metal such as steel in a straight thin-walled cylindrical shape. This outer cylinder member 2 is formed with an inside diameter larger than the outside diameter of the flange portion 12 of the main shaft member 1, and with a length longer than each block portion 14 and shorter than the tubular portion 11. This outer cylinder member 2 is disposed coaxially on the outer side of the main shaft member 1 at a distance therefrom at a position radially overlapping with each block portion 14.

As a rubber material is vulcanized and molded integrally with the main shaft member 1 and the outer cylinder member 2, the rubber elastic body 3 is interposed between the main shaft member 1 and the outer cylinder member 2 and is formed in a substantially cylindrical shape. As this rubber elastic body 3 is vulcanized and bonded to the outer peripheral surface of the main shaft member 1 (including the inner end face of the flange portion 12) and to the inner peripheral surface of the outer cylinder member 2, the rubber elastic body 3 integrally connects the two members. In portions of this rubber elastic body 3 which are located on the outer sides of the respective block portions 14, the pair of hollow portions 31 are provided which are open in an end face away from the flange portion 12 and extend in the axial direction up to a vicinity of an end face on the flange portion 12 side. Each of these hollow portions 31 is formed in such a manner as to extend up to a position slightly short of the flange portion 12-side end face of each block portion 14, and to surround each block 14.

This rubber elastic body 3 has the pair of non-deforming rubber portions 32 which are disposed between the flange portion 12 and the respective block portion 14 of the main shaft member 1 and are substantially undeformable with respect to the application of an axial load. It should be noted that, at the time of the application of a load acting in a direction perpendicular to the axis, these non-deforming rubber portions 32 are deformed, though slightly, due to compression, tension, or shearing by accompanying the deformation of the connecting portions 33 connected to these non-deforming rubber portions 32. These non-deforming rubber portions 32 formed are of a size substantially identical to the shape of one axial end face of each block portions 14. Further, the connecting portion 33 for connecting the respective non-deforming rubber portion 32 and the inner peripheral surface of the end portion of the outer cylinder member 2 is provided between the bottom of each hollow portion 31 and an end face of the rubber elastic body 3 on the flange portion 12 side. Each of these connecting portions 33 is formed such that an inner peripheral side portion of the flange portion 12-side end face of the rubber elastic body 3 is inclined in such a manner as to approach the axially inward side as it is headed toward the outer peripheral side. Therefore, each of these connecting portions 33 is formed in a state of being offset axially inwardly of the respective non-deforming rubber portion 32.

It should be noted that since the rubber elastic body 3 is arranged as described above, in the vibration isolating bushing of this embodiment, the spring ratio between the direction perpendicular to the axis (the direction connecting the hollow portions 31, i.e., the vertical direction of the automobile) and the axial direction (the longitudinal direction of the automobile) is set to be 1:0.6. In addition, since each non-deforming rubber portion 32 is provided between the flange portion 12 and each block portion 14, and each connecting portion 33 is provided so as to connect each non-deforming rubber portion 32 and the inner peripheral surface of the end portion of the outer cylinder member 2, the vibration isolating bushing is prevented from becoming large in size and high in cost as compared with conventional cases in which an axial stopper is added and an axially compressive portion of the rubber elastic body is added.

The vibration isolating bushing of this embodiment constructed as described above is used as a trailing arm bushing for connecting the trailing arm and the vehicle body in a vibration isolated manner in a rear suspension. In this case, the tailing arm bushing is mounted by fixing the main shaft member 1, for instance, to the vehicle body by means of mounting bolts or the like, and by press fitting and fixing the outer cylinder member 2 in a mounting hole provided in the trailing arm. The axial direction of the vibration isolating bushing is set substantially in the longitudinal direction of the automobile, and the pair of hollow portions 31 in the rubber elastic body 3 are arranged in a state of being located substantially in the vertical direction of the automobile.

Further, the vibration (relative displacement) occurring between the trailing arm and the vehicle body is absorbed by the elastic deformation of the rubber elastic body 3, and the transmission of the vibration to the other member is thereby reduced. In addition, when the automobile turns, the spring action in the direction perpendicular to the axis and in the axial direction of the rubber elastic body 3 harmonizes, thereby functioning to cause the rear tire to undergo a toe-in. At this time, in the vibration isolating bushing of this embodiment, since the hollow portions 31, the non-deforming rubber portions 32, and the connecting portions 33 are provided in the rubber elastic body 3 in the above-described manner, the spring ratio in the axial direction is increased, and the spring ratio in the axial direction with respect to the spring in the direction perpendicular to the axis is increased. Therefore, the delay of the toe-in of the rear tire is suppressed.

As described above, in accordance with the vibration isolating bushing of this embodiment, since the rubber elastic body 3 has the hollow portions 31, the non-deforming rubber portions 32, and the connecting portions 33 which are provided in the above-described manner, it is possible to increase the spring ratio in the axial direction while preventing the vibration isolating bushing from becoming large in size and high in cost. Thus it is possible to suppress the delay of the toe-in of the rear tire when the automobile turns.

In addition, each block portion 14 of the main shaft member 1 in this embodiment is provided such that its radially outwardly protruding end face (outer peripheral surface) is located radially inwardly of the outer peripheral end of the flange portion 12. Therefore, the structure can be made such that the axial load applied to the rubber elastic body 3 can be easily relieved by receiving the resistance of the flange portion 12. Thus the non-deforming rubber portions 32 which are each disposed between the flange portion 12 and the respective block portion 14 can be provided advantageously.

In addition, the connecting portions 33 in this embodiment are each formed in a state of being offset axially inwardly of the respective non-deforming rubber portion 32. Therefore, since the structure becomes such that a compressive component is added with respect to the application of the axial load, it is possible to effectively increase the spring in the axial direction of the rubber elastic body 3.

It should be noted that although the block portions 14 of the main shaft member 1 in this embodiment are rigid members formed of a metal, they may be formed of rigid members such as hard plastics. In addition, although in this embodiment the pair of block portions 14 are disposed at axially symmetrical positions, the block portions 14 may be increased in number and may be provided discontinuously at intervals. Still alternatively, the block portion 14 may be formed annularly and may be provided over the entire circumferential region in a circumferentially continuous manner.

In addition, although the flange portion 12 of the main shaft member 1 in this embodiment is formed annularly and is provided over the entire circumferential direction, the flange portion 12 may be provided partially at positions axially opposing the block portions 14.

What is claimed is:

1. A vibration isolating bushing comprising:
a main shaft member including a tubular portion, a flange portion extending radially outwardly from one end of the tubular portion, and a block portion provided on a central portion of the tubular portion and distanced from the flange portion in an axial direction of the main shaft member;
an outer cylinder member disposed coaxially on an outer side of the main shaft member at a distance therefrom; and
a rubber elastic body disposed between the main shaft member and the outer cylinder member for integral connection of the main shaft member and the outer cylinder member, the rubber elastic body including a hollow portion which is open in an end face away from the flange portion and extends in the axial direction up to the vicinity of an end face on a side of the flange portion;
wherein the rubber elastic body further includes a non-deforming rubber portion and a connecting portion;
the non-deforming rubber portion is positioned between the flange portion and the block portion and is substantially undeformable with respect to an application of an axial load;
the connecting portion is positioned between a bottom of the hollow portion and the end face of the rubber elastic body on the side of the flange portion, for connecting the non-deforming rubber portion and an inner peripheral surface of an end portion of the outer cylinder member.

2. The vibration isolating bushing according to claim 1,
wherein the block portion has a radially outwardly protruding end face located more inwardly than an outer peripheral end of the flange portion.

3. The vibration isolating bushing according to claim 1,
wherein the connecting portion is formed in a state of being offset axially inwardly of the non-deforming rubber portion.
